(19) United States
(12) Patent Application Publication
(10) Pub. No.: US 2025/0067431 A1
(43) Pub. Date: Feb. 27, 2025

(54) PLATE-SHAPED HEAT INSULATOR, COMBUSTION CHAMBER, BOILER AND WATER HEATER

(71) Applicant: IBIDEN CO., LTD., Ogaki-shi (JP)

(72) Inventors: Takahiko OKABE, Ibi-gun (JP); Hiroaki TAKEUCHI, Ibi-gun (JP)

(73) Assignee: IBIDEN CO., LTD., Ogaki-shi (JP)

(21) Appl. No.: 18/942,738

(22) Filed: Nov. 10, 2024

Related U.S. Application Data
(62) Division of application No. 17/988,759, filed on Nov. 17, 2022.

(30) Foreign Application Priority Data
Nov. 18, 2021 (JP) 2021-188068

(51) Int. Cl. F23M 5/02; F22B 21/34; F24H 1/00; F24H 9/02

(52) U.S. Cl. CPC F23M 5/02; F24H 9/02; B32B 2262/10; B32B 2307/304; B32B 2307/72; F22B 21/348; F24H 1/0027

(57) ABSTRACT

A plate-shaped heat insulator including a plate-shaped papermaking product containing inorganic fibers, and one or more grooves in at least one of its surfaces. The plate-shaped heat insulator is intended to be disposed in a combustion chamber.

### CROSS-REFERENCE TO RELATED APPLICATION

The present application is a divisional application of U.S. application Ser. No. 17/988,759, filed on Nov. 17, 2022, and claims priority to Japanese Application No. 2021-188068, filed on Nov. 18, 2021, the entire contents of which are herein incorporated by reference.

### TECHNICAL FIELD

The present invention relates to a plate-shaped heat insulator, a combustion chamber, a boiler, and a water heater.

### BACKGROUND ART

Boilers and water heaters have been used as devices for supplying steam and hot water using fuels such as oil.

In boilers and water heaters, a fuel is combusted in a combustion chamber, and the combustion heat is transferred to water through a water pipe in the combustion chamber for heat exchange, whereby steam and hot water are generated from water.

The combustion chamber is subjected to high temperatures and is thus usually protected with a refractory or a heat insulator to protect peripheral devices from heat damage and to reduce energy loss (for example, see Patent Literature 1 and Patent Literature 2).

Common refractories or heat insulators for use particularly in the combustion chamber subjected to high temperatures from a combustion gas include one obtained by pouring a fluid containing a heat-resistant material onto a surface of a target object and solidifying the fluid thereon. Such a material is also referred to as a castable material.

### CITATION LIST

### Patent Literature

Patent Literature 1: JP 4946594 B
Patent Literature 1: JP 4640705 B

### SUMMARY OF INVENTION

### Technical Problem

While the castable material can follow a surface of any shape to impart heat insulation, the castable material is heavy and thus has poor workability during construction. The castable material after being mounted on the target object is fragile and easily breaks from thermal shock or vibration.

The present invention was made to solve the above issue. An object of the present invention is to provide a plate-shaped heat insulator with good workability during construction and less susceptible to damage after construction.

### Solution to Problem

Specifically, the plate-shaped heat insulator of the present invention include a plate-shaped papermaking product containing inorganic fibers, wherein the plate-shaped heat insulator is intended to be disposed in a combustion chamber.

Since the plate-shaped heat insulator of the present invention includes a plate-shaped papermaking product, the plate-shaped heat insulator has a low weight per volume and has good workability as compared to the castable material. The plate-shaped papermaking product containing inorganic fibers is a papermaking product obtained by attaching a binder to inorganic fibers in a slurry liquid and subjecting the inorganic fibers to papermaking in such a manner that the inorganic fibers are less unevenly dispersed. Such a plate-shaped papermaking product is mainly made of inorganic fibers and is thus less likely to break from thermal shock or vibration, unlike the castable material mainly containing inorganic particles.

Preferably, the plate-shaped heat insulator of the present invention further includes one or more grooves in at least one of its surfaces.

When the plate-shaped heat insulator is disposed such that a surface including a groove among the surfaces faces the inside of the combustion chamber, such a configuration can reduce or prevent cracking in the plate-shaped heat insulator due to thermal shrinkage, specifically in the surface adjacent to the combustion chamber where the plate-shaped heat insulator is particularly susceptible to heating.

In the plate-shaped heat insulator of the present invention, preferably, the multiple grooves are parallel to each other when the plate-shaped heat insulator is viewed in a thickness direction.

The multiple grooves in parallel divide the surface, which is adjacent to the combustion chamber subjected to high temperatures, of the plate-shaped heat insulator into multiple surfaces so that thermal shrinkage occurs in separate surfaces. This can reduce or prevent cracking in the plate-shaped heat insulator.

In the plate-shaped heat insulator of the present invention, preferably, the multiple grooves cross each other when the plate-shaped heat insulator is viewed in the thickness direction.

The multiple grooves crossing each other divide the surface, which is adjacent to the combustion chamber subjected to high temperatures, of the plate-shaped heat insulator into a greater number of surfaces to spread the surfaces subjected to thermal shrinkage. This can reduce or prevent cracking in the plate-shaped heat insulator.

Preferably, the plate-shaped heat insulator of the present invention further includes one or more recesses in at least one of its surfaces.

When the plate-shaped heat insulator is disposed such that a surface including the recess among the surfaces faces the outside of the combustion chamber, the recess can function as an air layer to improve the heat insulation.

In the plate-shaped heat insulator of the present invention, preferably, the inorganic fibers include at least one selected from the group consisting of biosoluble fibers, alumina fibers, rock wool, and glass fibers.

When the inorganic fibers include any of these materials, the resulting plate-shaped heat insulator has excellent heat resistance.

In the plate-shaped heat insulator of the present invention, preferably, the inorganic fibers have an average fiber length of 0.05 to 3.0 mm.

The inorganic fibers having an average fiber length in the above range result in a stack of plate-shaped molded products with less uneven distribution of the inorganic fibers, thus stabilizing the bulk density and heat insulation properties.

In the plate-shaped heat insulator of the present invention, preferably, the plate-shaped heat insulator has a bulk density of 0.2 to 0.6 g/cm³.

When the plate-shaped heat insulator has a bulk density in the above range, an increase in weight of the combustion chamber can be reduced or prevented as compared to a refractory material or a heat insulator containing an amorphous product.

The combustion chamber of the present invention includes a metal container and the plate-shaped heat insulator of the present invention on an inner wall surface of the metal container.

Since the combustion chamber of the present invention includes the plate-shaped heat insulator of the present invention on the inner wall surface of the metal container, the plate-shaped heat insulator is less susceptible to breakage.

In the combustion chamber of the present invention, preferably, the plate-shaped heat insulator includes a recess in a surface adjacent to the metal container.

When the plate-shaped heat insulator includes a recess in the surface adjacent to the metal container, the recess can function as an air layer to improve the heat insulation.

In the combustion chamber of the present invention, preferably, the plate-shaped heat insulator includes a groove in a surface away from the metal container.

When the plate-shaped heat insulator includes a groove in the surface away from the metal container, such a configuration can reduce or prevent cracking in the plate-shaped heat insulator due to thermal shrinkage, specifically in the surface adjacent to the combustion chamber where the plate-shaped heat insulator is particularly susceptible to heating.

In the combustion chamber of the present invention, preferably, the plate-shaped heat insulator is on a top surface or a bottom surface of the metal container, and a space between a side surface of the plate-shaped heat insulator and an inner surface of the metal container is filled with an amorphous material containing an inorganic material.

In some cases, it is difficult to completely adjust the dimension of the metal container and the dimension of the plate-shaped heat insulator such that no gap is present therebetween. Even in such cases, a reduction in heat insulation can be reduced or prevented when the space between the side surface of the plate-shaped heat insulator and the inner surface of the metal container is filled with the amorphous material.

The boiler of the present invention includes the combustion chamber of the present invention.

The boiler of the present invention, which includes the combustion chamber of the present invention, can reduce or prevent heat damage to peripheral devices. Further, the plate-shaped heat insulator has good workability during construction and is less susceptible to damage after construction. Thus, a reduction in energy efficiency associated with damage to the plate-shaped heat insulator is less likely to occur.

The water heater of the present invention includes the combustion chamber of the present invention.

The water heater of the present invention, which includes the combustion chamber of the present invention, can reduce or prevent heat damage to peripheral devices. Further, the plate-shaped heat insulator has good workability during construction and is less susceptible to damage after construction. Thus, a reduction in energy efficiency associated with damage to the plate-shaped heat insulator is less likely to occur.

### BRIEF DESCRIPTION OF DRAWINGS

FIG. 1 is a schematic perspective view of an example of a plate-shaped heat insulator according to a first embodiment of the present invention.

FIG. 2 is a cross-sectional view taken along line A-A in FIG. 1.

FIG. 3 is a schematic perspective view of an example of a plate-shaped heat insulator according to a second embodiment of the present invention.

FIG. 4 is a cross-sectional view taken along line B-B in FIG. 3.

FIG. 5 is a schematic perspective view of an example of a plate-shaped heat insulator according to a third embodiment of the present invention.

FIG. 6 is a cross-sectional view taken along line C-C in FIG. 5.

FIG. 7 is a schematic perspective view of an example of a plate-shaped heat insulator according to a fourth embodiment of the present invention.

FIG. 8 is a schematic perspective view of an example of a plate-shaped heat insulator according to a fifth embodiment of the present invention.

FIG. 9 is a cross-sectional view taken along line D-D in FIG. 8.

FIG. 10 is a schematic perspective view of an example of a combustion chamber according to a sixth embodiment of the present invention.

FIG. 11 is a cross-sectional view taken along E-E in FIG. 10.

FIG. 12 is a schematic cross-sectional view of an example of a combustion chamber according to a seventh embodiment of the present invention.

FIG. 13 is a schematic cross-sectional view of an example of a combustion chamber according to an eighth embodiment of the present invention.

FIG. 14 is a schematic cross-sectional view of an example of a combustion chamber according to a ninth embodiment of the present invention.

FIG. 15 is a schematic cross-sectional view of an example of a boiler according to a tenth embodiment of the present invention.

FIG. 16 is a schematic cross-sectional view of an example of a water heater according to an eleventh embodiment of the present invention.

### DESCRIPTION OF EMBODIMENTS

### [Plate-Shaped Heat Insulator]

First, the plate-shaped heat insulator of the present invention is described.

The plate-shaped heat insulator of the present invention includes a plate-shaped papermaking product containing inorganic fibers, wherein the plate-shaped heat insulator is intended to be disposed in a combustion chamber.

Herein, the term “plate-shaped” refers to a shape having two relatively large main surfaces facing each other and a side surface connecting the two main surfaces. A direction in which the two main surfaces extend is also referred to as the plane direction, and a direction in which the two main surfaces are connected is also referred to as the thickness direction. At least one of the two main surfaces facing each other may be curved.

Herein, the term “papermaking product” refers to a molded product obtained by pouring slurry containing an inorganic fiber into a mold and dehydrating the slurry by suction for papermaking molding and drying the resulting product (papermaking method). The term “plate-shaped papermaking product” refers to a plate-shaped product obtained by the papermaking method.

### First Embodiment

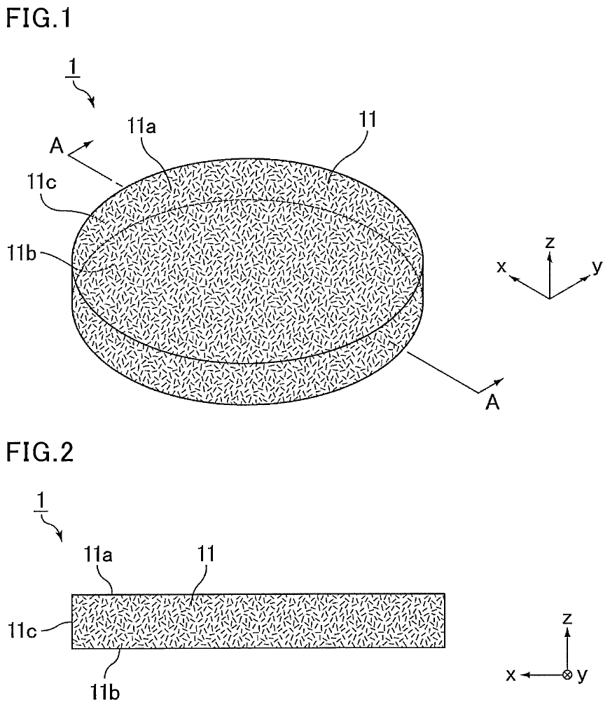

FIG. 1 is a schematic perspective view of an example of a plate-shaped heat insulator according to a first embodiment of the present invention. FIG. 2 is a cross-sectional view taken along line A-A in FIG. 1.

A plate-shaped heat insulator 1 shown in FIG. 1 includes a plate-shaped papermaking product 11 containing an inorganic material.

The plate-shaped papermaking product 11 has a plate shape including a first main surface 11a and a second main surface 11b having relatively large areas and facing each other, and a side surface 11c connecting the first main surface 11a and the second main surface 11b.

The first main surface 11a and the second main surface 11b are substantially circular when viewed in a thickness direction (z-direction). Thus, the outer shape of each of the plate-shaped papermaking product 11 and the plate-shaped heat insulator 1 is also described as a disc shape having a predetermined thickness.

Since the plate-shaped heat insulator 1 includes the plate-shaped papermaking product 11, the plate-shaped heat insulator has a low weight per volume and has good workability as compared to the castable material. The plate-shaped papermaking product 11 is characteristically less deformable with less uneven distribution of the inorganic fibers and is thus suitable as a heat insulator to be disposed in a combustion chamber.

As shown in FIG. 1 and FIG. 2, the plate-shaped heat insulator 1 includes only the plate-shaped papermaking product 11, so that the plate-shaped papermaking product 11 is the plate-shaped heat insulator 1.

Specifically, in the plate-shaped heat insulator of the present invention, the plate-shaped papermaking product itself may be a plate-shaped heat insulator.

The plate-shaped papermaking product contains inorganic fibers.

Preferably, the inorganic fibers include at least one selected from the group consisting of biosoluble fibers, alumina fibers, rock wool, and glass fibers.

The biosoluble fibers can be alkaline earth silicate fibers.

When the inorganic fibers include any of these materials, the resulting plate-shaped papermaking product has excellent heat resistance.

The average fiber diameter of the inorganic fibers is not limited, but it is preferably 2.0 to 15.0 μm.

The inorganic fibers having an average fiber diameter in the above range result in a dense plate-shaped papermaking product with less uneven distribution of the density.

The average fiber length of the inorganic fibers is not limited, but it is preferably 0.05 to 3.0 mm.

The inorganic fibers having an average fiber length in the above range result in a plate-shaped multilayer papermaking product with less uneven distribution of the inorganic fibers, stabilizing the bulk density and heat insulation properties.

Preferably, the plate-shaped papermaking product has a bulk density of 0.2 to 0.6 g/cm³.

When the plate-shaped papermaking product has a bulk density in the above range, an increase in weight of the combustion chamber can be reduced or prevented as compared to a refractory material or a heat insulator containing an amorphous material.

The bulk density can be adjusted by adjusting compression conditions during dehydration of the slurry and compression conditions during drying, for example.

The bulk density of a refractory material or a heat insulator containing an amorphous material is usually about 0.7 to about 1.5 g/cm³. The bulk density of the plate-shaped product produced by needling is usually about 0.07 to about 0.18 g/cm³. Neither of them satisfies the preferred bulk density of the plate-shaped papermaking product described above.

Preferably, the plate-shaped papermaking product has a thickness of 1 to 10 cm.

When the plate-shaped papermaking product has a thickness in the above range, the plate-shaped heat insulator can exhibit sufficient insulation.

Preferably, the area (plan view area) of the plate-shaped papermaking product viewed in the thickness direction is 350 to 15000 cm².

Preferably, the plate-shaped papermaking product has a volume of 700 to 150000 cm³.

When the plate-shaped papermaking product has a volume in the above range, damage due to thermal shrinkage is particularly less likely to occur.

The plate-shaped papermaking product may include a hole penetrating in the thickness direction.

Such a hole in the heat insulator facilitates covering of inner wall surfaces of the combustion chamber including pipes such as a water pipe and a flue gas pipe with the heat insulator.

The plate-shaped papermaking product may contain one or more components in addition to the inorganic fibers.

Examples of the one or more components in addition to the inorganic fibers include inorganic particles, inorganic binders, organic binders, and coagulants.

Example of the inorganic particles include silica particles, alumina particles, titania particles, zirconia particles, and natural mineral particles.

Examples of the inorganic binder include silica sol, alumina sol, titania sol, zirconia sol, and fumed silica.

Examples of the organic binder include polyvinyl alcohol, starch, acrylic resin, and polyacrylamide.

Preferably, the weight percentage of inorganic fibers in the weight plate-shaped papermaking product is 30 to 97 wt %.

The plate-shaped heat insulator of the present invention may include a groove in at least one of its surfaces.

Examples of a case where a groove is provided in one of the surfaces are described below as second to fourth embodiments.

### Second Embodiment

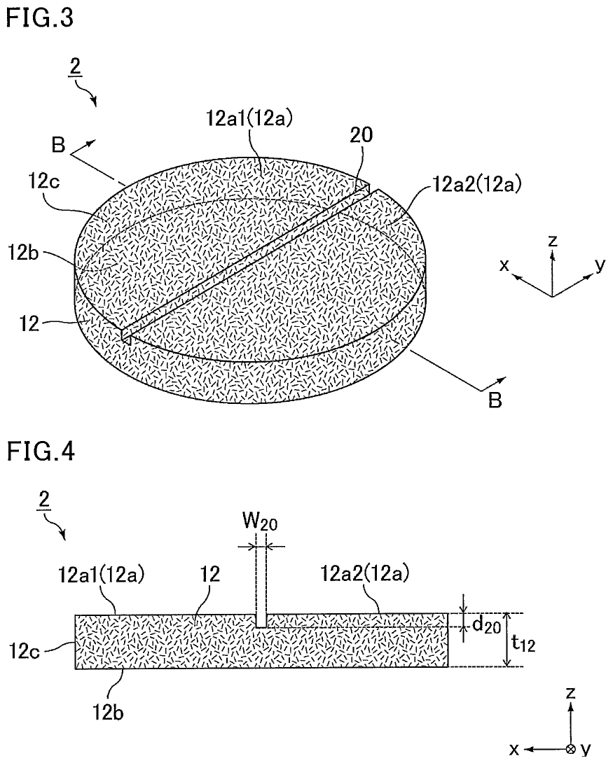

FIG. 3 is a schematic perspective view of an example of a plate-shaped heat insulator according to a second embodiment of the present invention. FIG. 4 is a cross-sectional view taken along line B-B in FIG. 3.

A plate-shaped heat insulator 2 shown in FIG. 3 includes a plate-shaped papermaking product 12 containing inorganic fibers.

The plate-shaped papermaking product 12 has a plate shape including a first main surface 12a and a second main surface 12b having relatively large areas and facing each other, and a side surface 12c connecting the first main surface 12a and the second main surface 12b.

As shown in FIG. 3 and FIG. 4, a groove 20 is formed in the first main surface 12a of the plate-shaped papermaking product 12.

The groove 20 in the first main surface 12a of the plate-shaped papermaking product 12 divides the first main surface 12a of the plate-shaped papermaking product 12 into two parts including a first main surface 12a1 and a first main surface 12a2. The surface of the plate-shaped papermaking product divided by the groove is less susceptible to cracking due to thermal shrinkage. Thus, when the plate-shaped heat insulator is disposed such that the surface including the groove faces the inside of the combustion chamber, such a configuration can reduce or prevent cracking in the plate-shaped heat insulator due to thermal shrinkage.

As shown in FIG. 4, the depth dimension of the groove 20 (in FIG. 4, the length indicated by a double-headed arrow d₂₀) is 25% of the thickness of the plate-shaped papermaking product 12 (in FIG. 4, the length indicated by a double-headed arrow t₁₂). The ratio (width dimension/depth dimension) of the width dimension (in FIG. 4, the length indicated by a double-headed arrow W₂₀) to the depth dimension d₂₀ of the groove 20 is about 0.75.

The groove 20 shown in FIG. 3 and FIG. 4 has a substantially rectangular cross-sectional shape in the direction perpendicular to the direction in which the groove extends. Yet, the cross-sectional shape of the groove is not limited thereto. For example, the groove may have a wedge shape or a semicircular shape.

Both ends of the groove 20 shown in FIG. 3 and FIG. 4 are exposed at the side surface 12c of the plate-shaped papermaking product 12. Yet, in the plate-shaped papermaking product of the present invention, only one end of the groove may be exposed at the side surface of the plate-shaped papermaking product, or both ends of the groove may not be exposed at the side surfaces of the plate-shaped papermaking product.

In order to reduce or prevent cracking due to thermal shrinkage in the main surface facing the inside of the combustion chamber, preferably, one of the ends of the groove is exposed at the side surface of plate-shaped papermaking product, and more preferably, both ends of the groove are exposed at the side surfaces of the plate-shaped papermaking product.

The groove may be formed during production of the plate-shaped papermaking product. Alternatively, the groove may be formed by processing a portion of the plate-shaped papermaking product after the production thereof.

Examples of the method of forming the groove by processing a portion of the plate-shaped papermaking product after the production thereof include blade processing or laser processing.

Preferably, the groove had a depth that is 10 to 50% of the thickness of the plate-shaped papermaking product.

Preferably, the width of the groove is a value at which the ratio of width dimension/depth dimension (described later) is 0.1 or more and less than 5.

The width and depth of a single groove may be constant or may vary among different parts of the groove.

The amount of heat applied to each part of the plate-shaped heat insulator may vary depending on the shape of the plate-shaped heat insulator and combustion conditions of a combustion chamber. In such a case, variation in the width and depth of the groove among the parts of the groove can alleviate stress resulting from the difference in amount of applied heat among the parts of the plate-shaped heat insulator, and cracking can be more effectively reduced or prevented.

When only one groove is formed in the surface as in the plate-shaped heat insulator shown in FIG. 3 and FIG. 4, preferably, the groove is formed at a position where the surface can be divided into two substantially equal parts.

Multiple grooves may be formed in the surface of the plate-shaped heat insulator. The multiple grooves may be formed in the same surface or different surfaces of the plate-shaped heat insulator.

The following describes a case where the multiple grooves are formed in the same surface of the plate-shaped heat insulator.

The multiple grooves may be parallel to each other when the plate-shaped heat insulator is viewed in the thickness direction.

An example of a case where the multiple grooves are parallel to each other when the plate-shaped heat insulator is viewed in the thickness direction is described below as a third embodiment.

### Third Embodiment

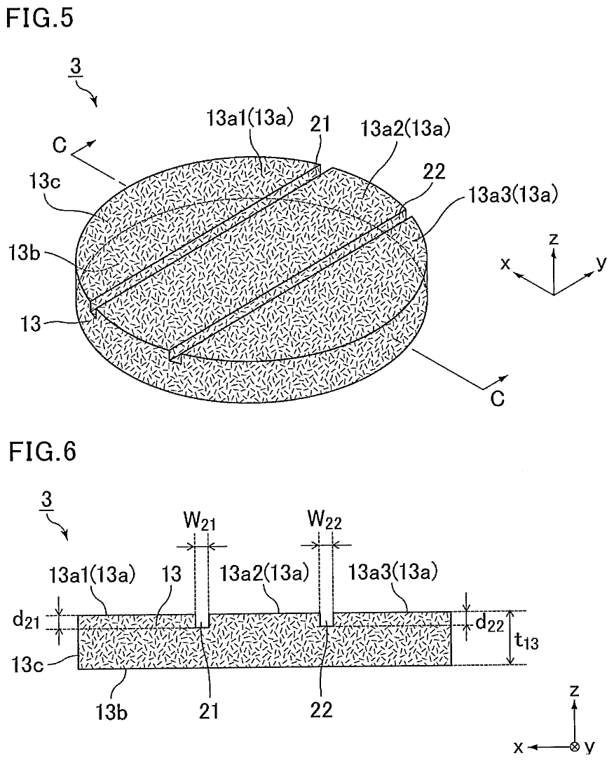

FIG. 5 is a schematic perspective view of an example of a plate-shaped heat insulator according a third embodiment of the present invention. FIG. 6 is a cross-sectional view taken along line C-C in FIG. 5.

A plate-shaped heat insulator 3 shown in FIG. 5 includes a plate-shaped papermaking product 13 containing inorganic fibers.

The plate-shaped papermaking product 13 has a plate shape including a first main surface 13a and a second main surface 13b having relatively large areas and facing each other, and a side surface 13c connecting the first main surface 13a and the second main surface 13b.

The plate-shaped papermaking product 13 includes two grooves 21 and 22 in the first main surface 13a.

The groove 21 and the groove 22 extend in a y-direction. Thus, the two grooves 21 and 22 are parallel to each other.

The grooves 21 and 22 formed in the first main surface 13a of the plate-shaped papermaking product 13 divide the first main surface 13a of the plate-shaped papermaking product 13 into three regions including a first main surface 13a1, a first main surface 13a2, and a first main surface 13a3. When the plate-shaped heat insulator is disposed such that the first main surface 13a divided by the grooves 21 and 22 faces the inside of a combustion chamber, cracking in the plate-shaped heat insulator due to thermal shrinkage can be reduced or prevented.

As shown in FIG. 6, the ratio of the width dimension (in FIG. 6, the length indicated by a double-headed arrow W₂₁) to the depth dimension (in FIG. 6, the length indicated by a double-headed arrow d₂₁) of the groove 21 is 1. Likewise, the ratio of the width dimension (in FIG. 6, the length indicated by a double-headed arrow W₂₂) to the depth dimension (in FIG. 6, the length indicated by a double-headed arrow d₂₂) of the groove 22 is 1.

The depth dimension d₂₁ of the groove 21 is 25% of the thickness of the plate-shaped papermaking product 13 (in FIG. 6, the length indicated by a double-headed arrow t₁₃). Likewise, the depth dimension d₂₂ of the groove 22 is 25% of the thickness of the plate-shaped papermaking product 13 (in FIG. 6, the length indicated by a double-headed arrow t₁₃).

FIG. 5 and FIG. 6 illustrate an example in which the multiple grooves are parallel to each other when the plate-shaped heat insulator is viewed in the thickness direction. Yet, in the plate-shaped heat insulator of the present invention, the multiple grooves may cross each other when the plate-shaped heat insulator is viewed in the thickness direction.

An example of a case where the multiple grooves cross each other when the plate-shaped heat insulator is viewed in the thickness direction is described below as a fourth embodiment.

### Fourth Embodiment

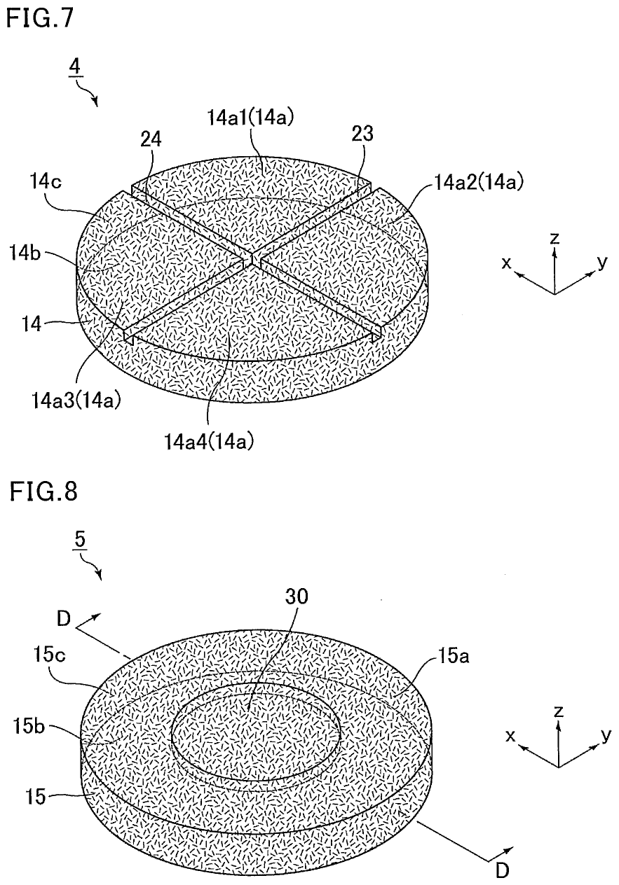

FIG. 7 is a schematic perspective view of an example of a plate-shaped heat insulator according to a fourth embodiment of the present invention.

A plate-shaped heat insulator 4 shown in FIG. 7 includes a plate-shaped papermaking product 14 containing inorganic fibers.

The plate-shaped papermaking product 14 has a plate shape including a first main surface 14a and a second main surface 14b having relatively large areas and facing each other, and a side surface 14c connecting the first main surface 14a and the second main surface 14b.

The plate-shaped papermaking product 14 includes two grooves 23 and 24 in the first main surface 14a.

The groove 23 extends in a y-direction and is formed at a position that divides the first main surface 14a into two substantially equal parts in an x-direction.

The groove 24 extends in the x-direction and is formed at a position that divides the first main surface 14a into two substantially equal parts in the y-direction.

The groove 23 and the groove 24 cross each other at an angle of about 90°. Thus, the first main surface 14a is divided into four parts by the groove 23 and the groove 24.

The angle at which the multiple grooves cross each other is not limited but is preferably 60° to 120°, more preferably 75° to 105°, still more preferably 90°.

When n grooves cross each other at an intersection of the multiple grooves, preferably, all the angles θ between adjacent grooves are equal. For example, preferably, when n is 3, θ is 120°; when n is 4, θ is 90°; when n is 5, θ is 72°; and when n is 6, θ is 60°. The “n” is the number of grooves extending from the intersection. Thus, in the plate-shaped heat insulator 4 shown in FIG. 7, a total of four grooves including two grooves 23 and two grooves 24 cross each other at the intersection.

FIG. 3 to FIG. 7 each illustrate an example in which the plate-shaped papermaking product includes the groove(s) only in one surface. Yet, in the plate-shaped heat insulator of the present invention, the plate-shaped papermaking product may include the grooves in both surfaces.

FIG. 5 to FIG. 7 each illustrate an example in which the multiple grooves are equal to each other in terms of depth, length, and width. Yet, the multiple grooves may or may not be equal to each other in terms of depth, length, and width.

The plate-shaped heat insulator of the present invention may include one or more recesses in at least one of its surfaces.

An example of a case where a recess is provided in the surfaces is described as a fifth embodiment.

### Fifth Embodiment

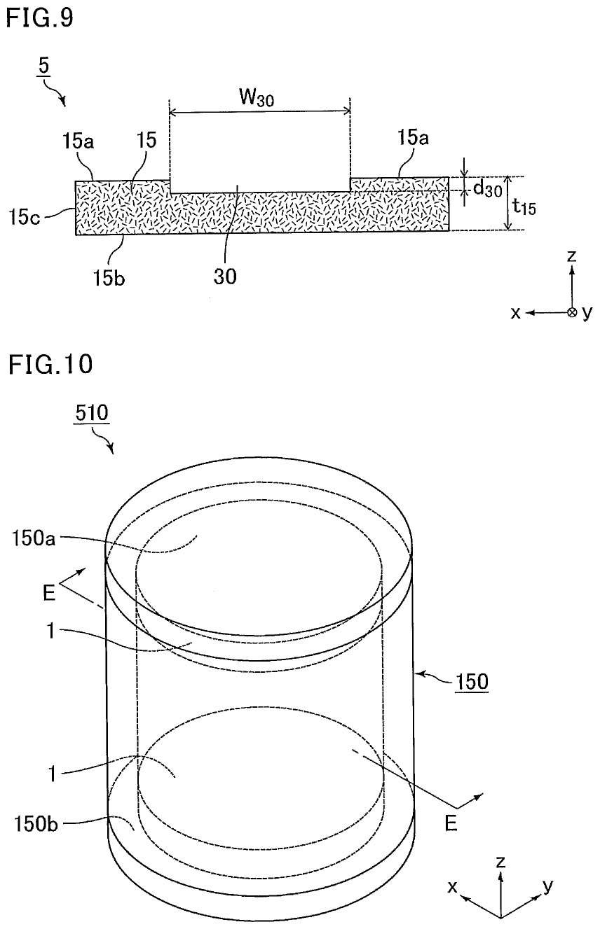

FIG. 8 is a schematic perspective view of an example of a plate-shaped heat insulator according to a fifth embodiment of the present invention. FIG. 9 is a cross-sectional view taken along line D-D in FIG. 8.

A plate-shaped heat insulator 5 shown in FIG. 8 includes a plate-shaped papermaking product 15 containing inorganic fibers.

The plate-shaped papermaking product 15 has a plate shape including a first main surface 15a and a second main surface 15b having relatively large areas and facing each other, and a side surface 15c connecting the first main surface 15a and the second main surface 15b.

The plate-shaped papermaking product 15 shown in FIG. 8 includes a recess 30 in the first main surface 15a.

The recess 30 in the first main surface 15a of the plate-shaped papermaking product 15 can function as an air layer when the plate-shaped papermaking product 15 is disposed such that the first main surface 15a faces the outside of a combustion chamber, improving the heat insulation of the plate-shaped papermaking product 15.

The plate-shaped papermaking product 15 has a substantially disc shape which is substantially circular in the plan view.

The shape of the recess 30 in the plan view is a substantially circular shape having a diameter half of the plate-shaped papermaking product 15. The center of the recess 30 substantially overlaps the center of the plate-shaped papermaking product 15.

The ratio (width dimension/depth dimension) of the width dimension (in FIG. 9, the length indicated by a double-headed arrow W₃₀) of the recess 30 to the depth dimension (in FIG. 9, the length indicated by a double-headed arrow d₃₀) of the recess 30 is about 13.5.

The depth dimension d₃₀ of the recess 30 is 25% of the thickness of the plate-shaped papermaking product 15 (in FIG. 9, the length indicated by a double-headed arrow t₁₅).

The recess may be formed during production of the plate-shaped papermaking product. Alternatively, the recess may be formed by processing a portion of the plate-shaped papermaking product after the production thereof.

Examples of the method of forming the recess by processing a portion of the plate-shaped papermaking product after the production thereof include blade processing or laser processing.

The recess may be exposed at an end (side surface) of the plate-shaped papermaking product.

Preferably, the depth dimension of the recess is 5 to 50% of the thickness of the plate-shaped papermaking product.

Preferably, the width of the recess is a value at which the ratio of width dimension/depth dimension (described later) is 5 or more and 40 or less.

Preferably, the area of the recess when the plate-shaped heat insulator is seen in the thickness direction is 10 to 60% of the area of the plate-shaped papermaking product.

For example, in the plate-shaped heat insulator 5 shown in FIG. 8 and FIG. 9, the diameter of the recess is half of the diameter of the plate-shaped papermaking product. Thus, the area of the recess 30 when the plate-shaped heat insulator is viewed in the thickness direction is 25% of the area of the plate-shaped papermaking product 15.

The plate-shaped papermaking product may include two or more recesses in the same surface.

When the plate-shaped papermaking product includes only one recess, preferably, the shape of the recess is similar to the shape of the plate-shaped heat insulator in the plan view, and preferably, the recess is disposed at a position including the center of gravity of the plate-shaped papermaking product when the plate-shaped heat insulator is viewed in the thickness direction.

In the plate-shaped heat insulator of the present invention, the plate-shaped papermaking product may include one or more grooves and one or more recesses in the same surface.

Herein, the recess and the groove are distinguished from each other by the ratio of the length in a width direction (hereinafter, width dimension) to the length in a depth direction (hereinafter, depth dimension) of the recess and the groove in a cross section perpendicular to the direction in which the recess and the groove extend. Specifically, one in which the ratio of the width dimension to the depth dimension is 5 or more is a recess, and one in which the above ratio is less than 5 is a groove.

### [Method of Producing a Plate-Shaped Papermaking Product]

The plate-shaped papermaking product defining the plate-shaped heat insulator of the present invention can be produced by the papermaking method in which slurry containing inorganic fibers is subjected to papermaking.

The slurry for producing the plate-shaped papermaking product may contain inorganic particles, an inorganic binder, an organic binder, a flocculant, and the like in addition to the inorganic fibers.

The slurry can suitably contain the same inorganic fibers, inorganic particles, inorganic binder, organic binder, and flocculant described above for the plate-shaped papermaking product defining the plate-shaped heat insulator of the present invention.

Preferably, the bulk density is adjusted to 0.2 to 0.6 g/cm³.

The bulk density can be adjusted by adjusting compression conditions during dehydration of the slurry and compression conditions during drying, for example.

A groove or recess may be formed, if necessary, in the surface of the plate-shaped product obtained by the papermaking method (plate-shaped papermaking product). Alternatively, the plate-shaped product may be molded to include a groove or recess at the beginning.

Examples of methods of forming a plate-shaped paper-making product including a groove or recess at the beginning include a method in which the slurry is molded in a mold with a projection or recess corresponding to the shape of the groove or recess and dehydrated.

Examples of methods of forming a groove or recess in a surface of the plate-shaped product obtained by the papermaking method include blade processing or laser processing.

The plate-shaped heat insulators of the present invention have been described so far.

Hereinafter, a combustion chamber of the present invention including any of the plate-shaped heat insulators of the present invention is described.

### [Combustion Chamber]

The combustion chamber of the present invention includes a metal container and the plate-shaped heat insulator of the present invention on an inner wall surface of the metal container.

Since the combustion chamber of the present invention includes the plate-shaped heat insulator of the present invention on the inner wall surface of the metal container, the plate-shaped heat insulator is less susceptible to breakage.

### Sixth Embodiment

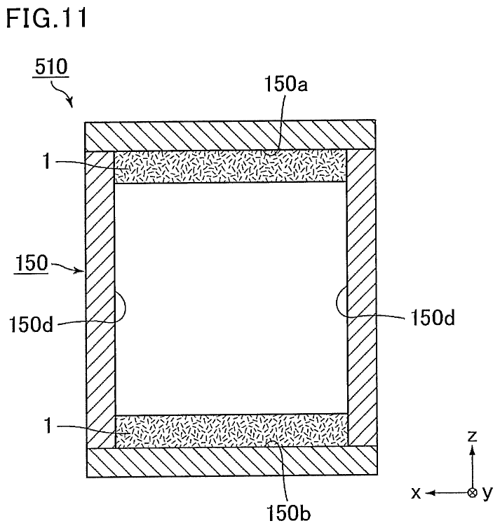

FIG. 10 is a schematic perspective view of an example of a combustion chamber according to a sixth embodiment of the present invention. FIG. 11 is a cross-sectional view taken along E-E in FIG. 10.

As shown in FIG. 10 and FIG. 11, a combustion chamber 510 includes a metal container 150 and two plate-shaped heat insulators 1 on inner wall surfaces of the metal container. Each plate-shaped heat insulator 1 is the plate-shaped heat insulator of the present invention.

An inner space of the metal container 150 is partitioned by a top surface 150a, a bottom surface 150b, and an inner surface 150d of the metal container 150. The top surface 150a, the bottom surface 150b, and the inner surface 150d of the metal container 150 are inner wall surfaces of the metal container 150 when the metal container 150 is seen from inside.

One of the two plate-shaped heat insulators 1 is disposed to cover the top surface 150a of the metal container 150 from the inside, and the other is disposed to cover the bottom surface 150b of the metal container 150 from the inside.

Each plate-shaped heat insulator 1 is disposed such that one of the main surfaces is adjacent to the metal container 150 (adjacent to the top surface 150a or the bottom surface 150b of the metal container 150), and the other main surface is away from the metal container 150.

The inner diameter dimensions of the top surface 150a and the bottom surface 150b of the metal container 150 match the outer dimension of the plate-shaped heat insulator 1. In a plane direction (xy-plane direction) of the plate-shaped heat insulator 1, no gap is present between the plate-shaped heat insulator 1 and the inner surface 150d of the metal container 150.

In the combustion chamber of the present invention, the plan view area of the top surface and/or bottom surface of the metal container on which the plate-shaped heat insulator of the present invention is disposed is preferably 350 to 15000 cm². The above area includes the area where a water pipe, a flue gas pipe, and the like are disposed on the top surface or bottom surface of the metal container.

In the combustion chamber of the present invention, a recess or a groove may be provided in a surface of the plate-shaped heat insulator, or a gap between the plate-shaped heat insulator and the metal container may be filled with an amorphous material containing an inorganic material.

Examples of such cases are described as seventh to ninth embodiments.

### Seventh Embodiment

In the combustion chamber of the present invention, preferably, the plate-shaped heat insulator includes a recess in a surface adjacent to the metal container.

When the plate-shaped heat insulator includes a recess in the surface adjacent to the metal container, the recess can function as an air layer to improve the heat insulation.

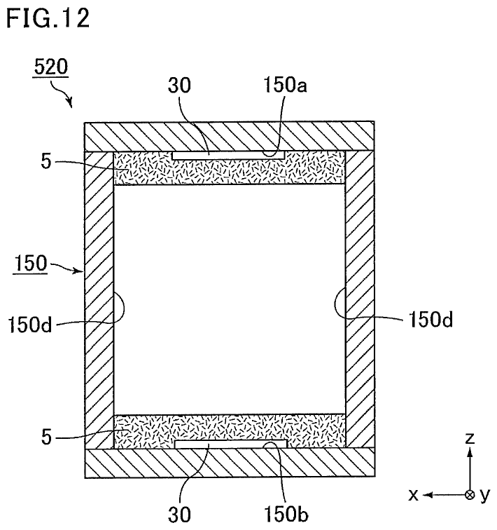

FIG. 12 is a schematic cross-sectional view of an example of a combustion chamber according to a seventh embodiment of the present invention.

As shown in FIG. 12, a combustion chamber 520 includes the metal container 150 and two plate-shaped heat insulators 5 on the top surface 150a and the bottom surface 150b of the metal container 150. The plate-shaped heat insulator 5 is an example of the plate-shaped heat insulator according to the fourth embodiment of the present invention, which is described in FIG. 8 and FIG. 9.

Each plate-shaped heat insulator 5 is disposed such that one of the main surfaces is adjacent to the metal container 150 (adjacent to the top surface 150a or the bottom surface 150b of the metal container 150) and the other main surface is away from the metal container 150.

Each plate-shaped heat insulator 5 includes the recess 30 in a surface adjacent to the metal container 150.

When the plate-shaped heat insulator 5 includes the recess 30 in the surface adjacent to the metal container 150, the recess 30 can function as an air layer to improve the heat insulation of the plate-shaped heat insulator 5.

### Eighth Embodiment

In the combustion chamber of the present invention, preferably, the plate-shaped heat insulator includes a groove in a surface away from the metal container.

When the plate-shaped heat insulator includes a groove in the surface away from the metal container, such a configuration can reduce or prevent cracking in the plate-shaped heat insulator due to thermal shrinkage, specifically in the surface adjacent to the combustion chamber where the plate-shaped heat insulator is particularly susceptible to heating.

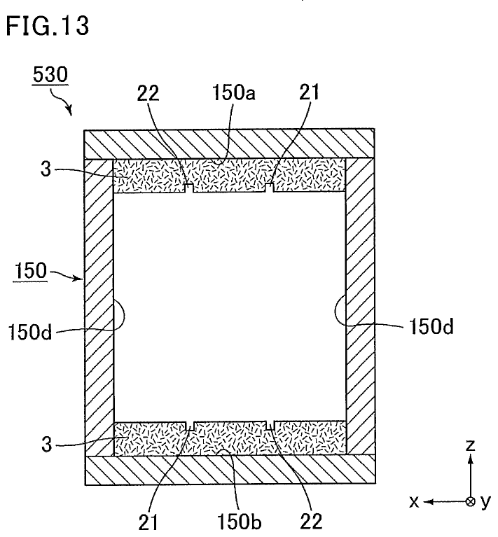

FIG. 13 is a schematic cross-sectional view of an example of a combustion chamber according to an eighth embodiment of the present invention.

As shown in FIG. 13, a combustion chamber 530 includes the metal container 150 and two plate-shaped heat insulators 3 on the top surface 150a and the bottom surface 150b of the metal container 150. The plate-shaped heat insulator 3 is an example of the plate-shaped heat insulator according to the third embodiment of the present invention, which is described in FIG. 5 and FIG. 6.

Each plate-shaped heat insulator 3 is disposed such that one of the main surfaces is adjacent to the metal container 150 (adjacent to the top surface 150a or the bottom surface 150b of the metal container 150) and the other main surface is away from the metal container 150.

Each plate-shaped heat insulator 3 includes the groove 21 and the groove 22 in the surface away from the metal container 150.

When the groove 21 and the groove 22 are in the surface away from the metal container 150, such a configuration can reduce or prevent cracking in the plate-shaped heat insulator 3 due to thermal shrinkage, specifically in the surface adjacent to the combustion chamber where the plate-shaped heat insulator 3 is particularly susceptible to heating.

### Ninth Embodiment

In the combustion chamber of the present invention, preferably, the plate-shaped heat insulator is on a top surface or a bottom surface of the metal container, and a space between a side surface of the plate-shaped heat insulator and an inner surface of the metal container is filled with an amorphous material containing an inorganic material.

In some cases, it is difficult to completely adjust the dimension of the metal container and the dimension of the plate-shaped heat insulator such that no gap is present therebetween. Even in such cases, a reduction in heat insulation can be reduced or prevented when the space between the side surface of the plate-shaped heat insulator and the inner surface of the metal container is filled with the amorphous material.

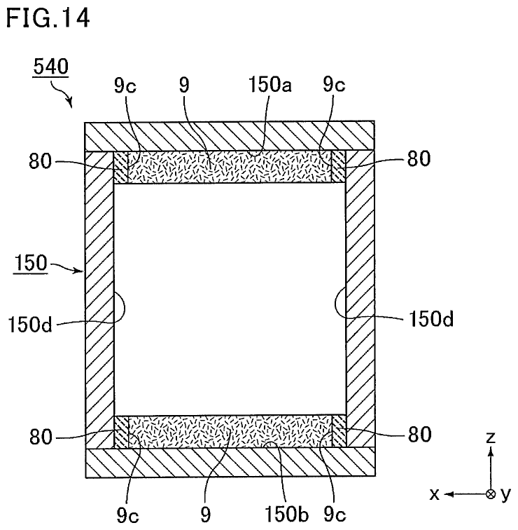

FIG. 14 is a schematic cross-sectional view of an example of a combustion chamber according to a ninth embodiment of the present invention.

As shown in FIG. 14, a combustion chamber 540 includes the metal container 150 and two plate-shaped heat insulators 9 on the top surface 150a and the bottom surface 150b of the metal container 150.

The plan view dimension (outer diameter dimension) of each plate-shaped heat insulator 9 is smaller than the inner diameter dimension of the inner surface 150d of the metal container 150. Thus, a gap is generated between a side surface 9c of the plate-shaped heat insulator 9 and the inner surface 150d of the metal container. The gap is filled with an amorphous material 80 containing an inorganic material. When the gap between the side surface 9c of the plate-shaped heat insulator 9 and the inner surface 150d of the metal container 150 is filled with the amorphous material 80, a reduction in heat insulation can be reduced or prevented.

Preferably, the distance between the side surface of the plate-shaped heat insulator and the inner side surface of the metal container is 0.5 to 5.0 mm.

When the distance between the side surface of the plate-shaped heat insulator and the inner side surface of the metal container is in the above range, a reduction in insulation can be sufficiently reduced or prevented by filling the gap with an amorphous material containing an inorganic material.

The distance between the side surface of the plate-shaped heat insulator and the inner side surface of the metal container may vary depending on the portion.

The combustion chamber of the present invention can be used in a device including a combustion chamber. Examples of the device including a combustion chamber include boilers and water heaters.

### [Boiler]

The boiler of the present invention includes the combustion chamber of the present invention.

The boiler of the present invention, which includes the combustion chamber of the present invention, can reduce or prevent heat damage to peripheral devices. Further, the plate-shaped heat insulator has good workability during construction and is less susceptible to damage after construction. Thus, a reduction in energy efficiency associated with damage to the plate-shaped heat insulator is less likely to occur.

An example of the boiler of the present invention is described below as a tenth embodiment.

### Tenth Embodiment

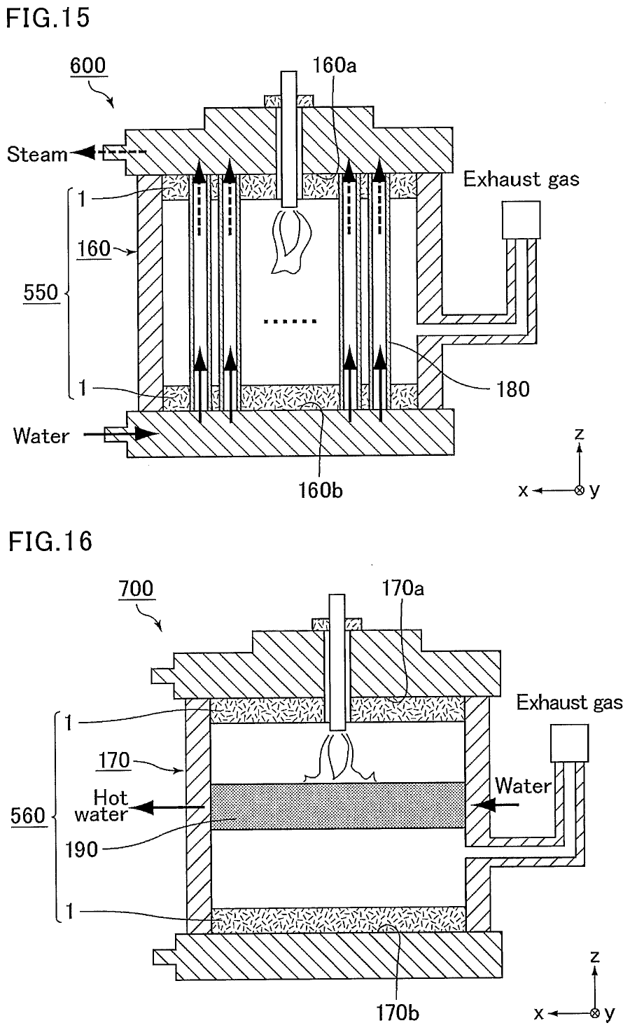

FIG. 15 is a schematic cross-sectional view of an example of a boiler according to a tenth embodiment of the present invention.

A boiler 600 includes a combustion chamber 550 and a water pipe 180 in the combustion chamber 550.

The combustion chamber 550 is a combustion chamber of the present invention including a metal container 160 and the plate-shaped heat insulators 1 of the present invention on a top surface 160a and a bottom surface 160b of the metal container 160.

Water is supplied into the water pipe 180 from a lower portion of the combustion chamber 550. Water flowing through the water pipe 180 is heated into steam in the combustion chamber 550, and the steam is exhausted from an upper portion of the combustion chamber 550.

The exhausted steam after water separation of the liquid or overheating as needed is used for applications such as power generation, heating, washing, cooking, drying, disinfection, and sterilization.

### [Water Heater]

The water heater of the present invention includes the combustion chamber of the present invention.

The water heater of the present invention, which includes the combustion chamber of the present invention, can reduce or prevent heat damage to peripheral devices. Further, the plate-shaped heat insulator has good workability during construction and is less susceptible to damage after construction. Thus, a reduction in energy efficiency associated with damage to the plate-shaped heat insulator is less likely to occur.

An example of the water heater of the present invention is described below as an eleventh embodiment.

### Eleventh Embodiment

FIG. 16 is a schematic cross-sectional view of an example of a water heater according to an eleventh embodiment of the present invention.

A water heater 700 includes a combustion chamber 560 and a heat exchanger 190 in the combustion chamber 560.

The combustion chamber 560 is a combustion chamber of the present invention including a metal container 170 and the plate-shaped heat insulators 1 of the present invention on a top surface 170a and a bottom surface 170b of the metal container 170.

Water flows in the heat exchanger 190. The water in the heat exchanger 190 is heated into hot water in the combustion chamber 560, and the hot water is supplied to the outside of the water heater 700.

The temperature of hot water to be supplied can be suitably adjusted by adjusting the amount of fuel to be combusted in the combustion chamber and the amount of water flowing through the heat exchanger per unit time.

### REFERENCE SIGNS LIST

1, 2, 3, 4, 5, 9 plate-shaped heat insulator
11, 12, 13, 14, 15 plate-shaped papermaking product
11a, 12a, 12a1, 12a2, 13a, 13a1, 13a2, 13a3, 14a, 14a1, 14a2, 14a3, 14a4, 15a first main surface of plate-shaped papermaking product
11b, 12b, 13b, 14b, 15b second main surface of plate-shaped papermaking product
9c, 11c, 12c, 13c, 14c, 15c side surface of plate-shaped papermaking product
20, 21, 22, 23, 24 groove
30 recess
80 amorphous material containing inorganic material
150, 160, 170 metal container
150a, 160a, 170a top surface of metal container
150b, 160b, 170b bottom surface of metal container
150d inner side surface of metal container
180 water pipe
190 heat exchanger
510, 520, 530, 540, 550, 560 combustion chamber
600 boiler
700 water heater

1. A plate-shaped heat insulator comprising
a plate-shaped papermaking product containing inorganic fibers, and
one or more grooves in at least one of its surfaces,
wherein the plate-shaped heat insulator is intended to be disposed in a combustion chamber.

2. The plate-shaped heat insulator according to claim 1,
wherein the multiple grooves are parallel to each other when the plate-shaped heat insulator is viewed in a thickness direction.

3. The plate-shaped heat insulator according to claim 1,
wherein the multiple grooves cross each other when the plate-shaped heat insulator is viewed in the thickness direction.

4. The plate-shaped heat insulator according to claim 1,
wherein the inorganic fibers include at least one selected from the group consisting of biosoluble fibers, alumina fibers, rock wool, and glass fibers.

5. The plate-shaped heat insulator according to claim 1,
wherein the inorganic fibers have an average fiber length of 0.05 to 3.0 mm.

6. The plate-shaped heat insulator according to claim 1,
wherein the plate-shaped heat insulator has a bulk density of 0.2 to 0.6 g/cm³.

7. The plate-shaped heat insulator according to claim 1,
wherein the plate-shaped papermaking product further contains inorganic particles, and
wherein the inorganic particles are solid particles.

8. The plate-shaped heat insulator according to claim 1,
wherein the plate-shaped papermaking product contains 50 to 97 wt % of inorganic fibers.

9. The plate-shaped heat insulator according to claim 1,
wherein the plate-shaped papermaking product has a disc shape that is circular in plan view.

10. The plate-shaped heat insulator according to claim 1,
wherein the inorganic fibers have an average fiber length of 0.05 to 3.0 mm,
wherein the plate-shaped heat insulator has a bulk density of 0.2 to 0.6 g/cm³,
wherein the plate-shaped papermaking product further contains inorganic particles, and
wherein the inorganic particles are solid particles.

11. The plate-shaped heat insulator according to claim 10,
wherein the plate-shaped papermaking product contains 50 to 97 wt % of inorganic fibers.

12. A combustion chamber comprising:
a metal container; and
the plate-shaped heat insulator according to claim 1 on an inner wall surface of the metal container.

13. A plate-shaped heat insulator comprising
a plate-shaped papermaking product containing inorganic fibers, and
further comprising one or more recesses in at least one of its surfaces,
wherein the plate-shaped heat insulator is intended to be disposed in a combustion chamber.

14. A combustion chamber comprising:
a metal container; and
a plate-shaped heat insulator on an inner wall surface of the metal container,
wherein the plate-shaped heat insulator comprising a plate-shaped papermaking product containing inorganic fibers.

15. The combustion chamber according to claim 14,
wherein the plate-shaped heat insulator includes a recess in a surface adjacent to the metal container.

16. The combustion chamber according to claim 14,
wherein the plate-shaped heat insulator includes a groove in a surface away from the metal container.

17. The combustion chamber according to claim 14,
wherein the plate-shaped heat insulator is on a top surface or a bottom surface of the metal container, and
a space between a side surface of the plate-shaped heat insulator and an inner surface of the metal container is filled with an amorphous material containing an inorganic material.

18. A boiler comprising
the combustion chamber according to claim 14.

19. A water heater comprising
the combustion chamber according to claim 14.
